(19) United States
(12) Patent Application Publication
(10) Pub. No.: US 2009/0321255 A1
(43) Pub. Date: Dec. 31, 2009

(54) Drug-meter: Multiwell membrane-based potentiometric sensor for high throughput tests of drugs

(76) Inventor: Nikolai Kocherginsky, Urbana, IL (US)

Correspondence Address: KOCHERGINSKY NIKOLAI M., 909 E. SUNNYCREST DRIVE, URBANA, IL, 61801, US

(21) Appl. No.: 12/147,486

(22) Filed: Jun. 27, 2008

(51) Int. Cl. G01N 27/26

(52) U.S. Cl. 204/403.06; 204/415

(57) ABSTRACT

Multiwell membrane-based potentiometric sensor for high throughput tests. The sensor includes a reference element under the bottom of the multiwell plate, where the bottoms of the wells have sensitive potentiometric membranes. The plate is made with the electrically nonconductive polymer. The output of the chemical sensor is a transmembrane voltage between additional reference element inserted into the test solution in a well and the first reference element. Potentials correspond to the chemical activity present in test solutions added into the wells. In one embodiment the membrane is a drug sensitive biomimetic membrane, made of porous nitrocellulose polymer support impregnated with lipids or lipid-like substances. Sensitivity for some drugs can be as good as 1 ppm. In other embodiments the membrane is an ion selective glass or polymer membrane, including PVC with ionophores or redox active electroconductive polymer membranes to characterize redox processes in the test solutions.

### BACKGROUND

I. The Field of the Invention

The invention relates to chemical sensors, and more particularly to membrane-based potentiometric sensors-electrodes used in analytical chemistry. Embodiments include a sensor with many membranes at the bottom of small wells, forming a multiwell plate. The membranes are used as separate sensing elements to measure different chemical species in investigated fluid samples in the wells.

II. The Prior Art

One of the most active areas of analytical chemistry and technology is the development of different chemical sensors, including membrane based potentiometric electrodes. Well-known examples of these electrodes are ion-selective electrodes, and especially pH electrodes. These electrodes are based on combination of an internal reference element and thin glass membrane, having H⁺ selective properties due to the chemical processes on glass/electrolyte interface. Inner volume of these electrodes is usually filled with acidic aqueous solutions. Other examples include K⁺, Na⁺, Ca²⁺, F⁻ and other ion selective electrodes based on polymer membranes with plasticizers and specific chelating agents immobilized in the membrane.

During the last decade or two new types of membrane electrodes were developed, especially flow-through and miniaturized electrodes, applicable in biomedical applications. Problems and shortcomings of these electrodes as the prior art are signal drift with time and error due to imperfectly selective membranes, and also fabrication difficulties.

Another area of modern analytical technology is development of high throughput systems, applicable for many analyses conducted with low volumes of the samples and high speed. This technology is especially important for analysis of biological fluids, blood and cell suspensions, and for preliminary drug screening. Necessity to analyze a lot of samples in different vials in one set usually means that a lot of miniaturized selective electrodes together with reference electrodes have to be used in the analytical setup, which poses significant obstacles to the wide-scale adoption of this method.

### OBJECTIVES AND BRIEF SUMMARY OF THE INVENTION

Objective of the present invention is to provide a new type of the membrane based sensor, so that it will be not necessary to insert a selective electrode in each separate vial with small volume of investigated fluid.

Another objective is to minimize the number of external electrical connections in the analytical system.

Another objective is to provide the system easily adjustable to existing technology of high through put drug screening.

Another important objective is to provide the sensor, which is sensitive to the concentrations of drugs in the biological fluids and their continuous changes due to drug transport and metabolism.

One more objective is to provide a differential method to measure changes or deviations of the drug concentration in comparison to the initial or standard concentration. In this case the method gives a linear response to the concentration changes, which can be more accurate and preferable than the log scale in the usual potentiometric arrangements.

Still another important objective is to provide an easy method of calibration, which reduces the error due to membrane aging, temperature, etc.

Yet another important purpose was to provide a sensor with a system of wells with different membranes, thus making it possible to measure with one sensor several different chemical parameters in different aliquots of the same fluid.

One more objective is to provide the sensor which is sensitive to the redox state and metabolism including respiration and oxygen absorption in the biological samples,

The forgoing and other objectives and features of the present invention are realized in a novel membrane sensor, which is fabricated as one reference electrochemical element, connected to the multi well plate with a system of separate selective membranes forming the bottoms of these wells. The multiwell plate covers another plate with the inner volume of this second plate filled with the standard aqueous solution and the reference element is in contact with this aqueous solution. The selective membranes provide an electrical signal measured as transmembrane potential, sensitive to a particular chemical or a group of chemicals. In one embodiment the multiwell plate has 95 separate wells with nitrocellulose filter based biomimetic membranes and one additional well is used to insert the electrochemical reference element, which forms electrical contact with aqueous or physiological solution filling the volume of the proposed sensor and contacting the membranes under the wells. In this case it is possible to measure concentrations of many physiologically active organic cations in the test solutions, including serum and protein solutions.

The foregoing and other objectives of the present invention and claims are more apparent from the following description and the accompanying drawings.

### BRIEF DESCRIPTION OF THE DRAWINGS

FIG. 1 illustrates an multiwell sensor used in the examples given below.

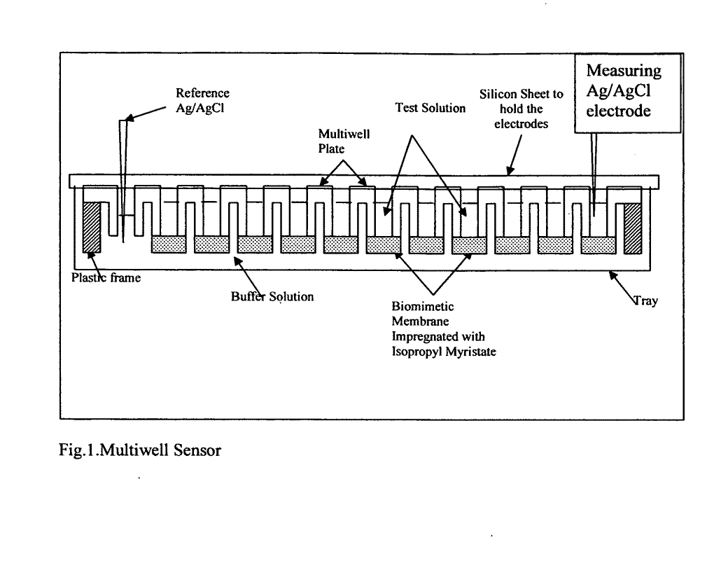

FIG. 2 shows calibration curve for Propranolol Hydrochloride.

FIG. 3 shows calibration curves for Fenfluramine HCl in buffer of various pH, 1M NaCl and pretreatment with aqueous salt solution.

FIG. 4 shows calibration curves with Fenfluramine HCl in Albumin solutions and FBS.

FIG. 5 shows kinetics of the potential formation when the measuring electrode is moved from one well to another.

FIG. 6 shows potential changes in time for 10⁻³ M Fenfluramine HCl in a buffer, pH8.

FIG. 7 shows calibration curves for Rimantadine Hydrochloride.

FIG. 8 shows Calibration Curves for Chlorpromazine Hydrochloride.

### DETAILED DESCRIPTION OF THE PRESENTLY PREFERRED EMBODIMENTS

### Experimental

### Biomimetic Membrane of the Multiwell Sensor

Multiwell plates used were commercial Millipore MultiScreen VM 0.05μ plates with nitrocellulose ultrafilters located at the base of each of the 96 wells of a plate. Though the number of the wells in the examples given in the disclosure is 96, as it is in the usual multiwell plates, it is not limited by this number and can be any from 2 and above.

All filters were impregnated by isopropyl myristate or some other lipid-like substances, like long chain fatty acids, their methyl and ethyl-esters, fats, etc. After impregnation the membranes should be translucent.

Each well requires as little as 200 μl of test solution. The small well's volume and the numerous wells (96) make the plates highly suitable as a part of the drug sensor, both for pharmaceutical testing in a buffer as well as for testing in biological fluids.

The tray cover can be is used as a base tray to put the reference buffer solution. Two Ag/AgCl electrodes with the salt bridges were used to measure transmembrane potential with common multimeter. It is possible to use one Ag/AgCl element as a measuring electrode and move it from one well to another. Another option is to have different measuring electrodes in different wells and separately to collect signals from each of them separately.

Kinetics of the process was registered with electrochemical station GPES. 5 mM Potassium Dihydrogen Phosphate solution in water was used as a buffer, filling the tray with the volume ˜30 ml. Known concentration of a drug (usually near 10⁻⁵ M) could be added in the buffer as the reference. Membrane resistance after impregnation was several megaohms and usually decreases after modification of the membrane with drugs. Resistance is much lower when the membrane is broken. In this case the measurements can be conducted in other wells with the same test solution.

In some cases drugs concentration was measured in albumin solutions with protein concentration 0.022 g/cm³ in buffer or Fetal Bovine Serum was used with concentration of serum albumin in the range 0.0187 g/cm³-0.022 g/cm³.

The base plate was filled with the buffer of reference concentration 5×10⁻⁶ M of drug, and the wells with albumin-drug solution, with constant concentration of albumin, but varying concentration of drug.

Using electrochemical station and computer it is possible to measure potential continuously in time, and for example, to study drug transport through the membrane. In this case it is possible to have different drugs or different types of membranes in different wells.

### Example 1

### Propranolol Hydrochloride

This is one of the most popular β-adrenergic receptor antagonists (β-blockers), used in clinics because of its efficiency in the treatment of hypertension, ischemic heart disease and certain arrhythmias.

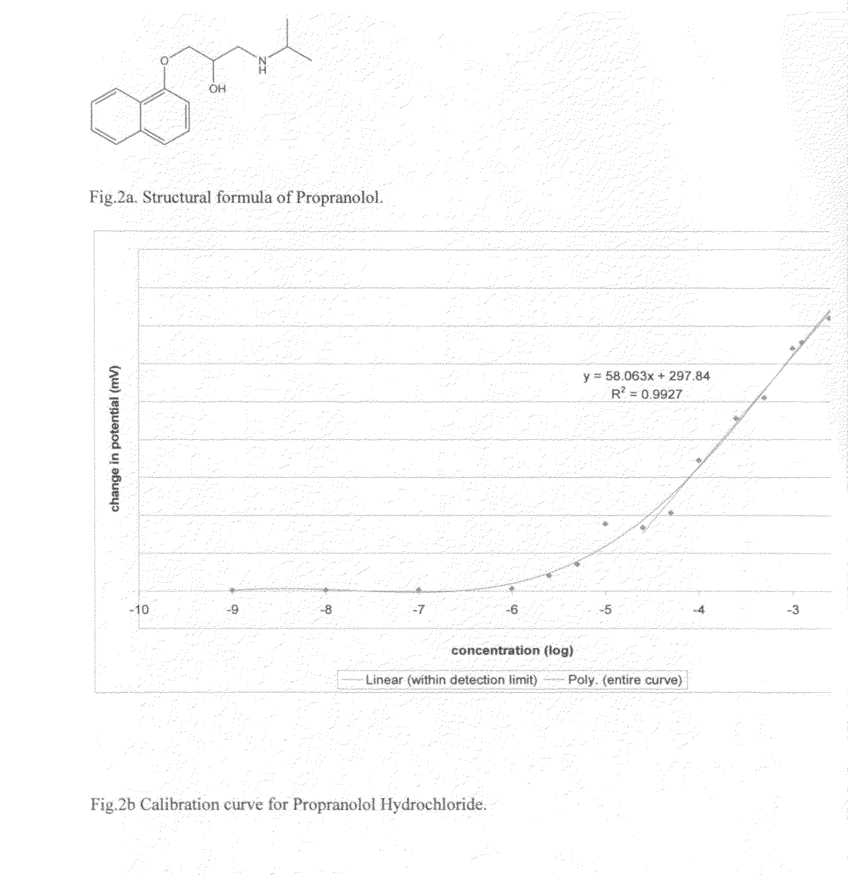

Presence of Propranolol hydrochloride in the test solution resulted in the formation of transmembrane electrical potential (FIGS. 2a and 2b). Sign of this potential demonstrated that the membrane has higher permeability of organic cation of the protonated drug molecule than that of Chloride anion. Dependence of transmembrane potential versus Log (concentration) at concentrations higher than 10⁻⁴ M gives a straight line and follows classical Nerst law with the slope near 58 mV per ten times concentration changes. The slope of the calibration curve for Propranolol in buffer demonstrates that the sensor is highly selective to Propranolol versus chloride. Range of the sensor sensitivity was from 10⁻⁵ to 10⁻² M.

It was possible to conduct similar experiments with chicken blood, but the Propranolol effects were observed only at higher drug concentrations because of the decrease of the efficient propranolol concentration in aqueous phase due to binding with blood proteins as it is shown below.

### Example 2

### Fenfluramine Hydrochloride in Aqueous Solutions

Antiobesity drug Pondimin, Fenfluramine Hydrochloride (+/−)-N-ethyl-α-methyl-m-(trifluoromethyl) phenethylamine HCl C₁₂H₁₆F₃N.HCl. Solubility in pH7.4 buffer is about 0.05M. Solubility in Fetal Bovine Serum is about 0.01 M

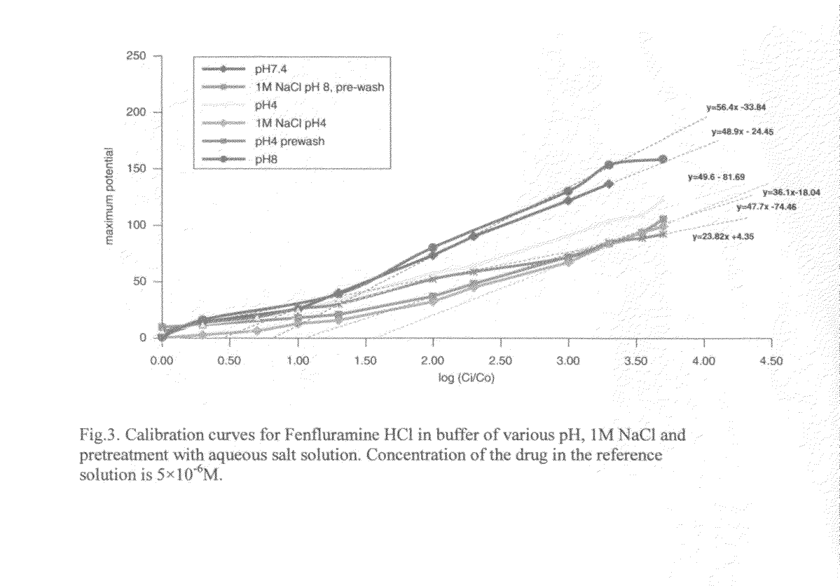

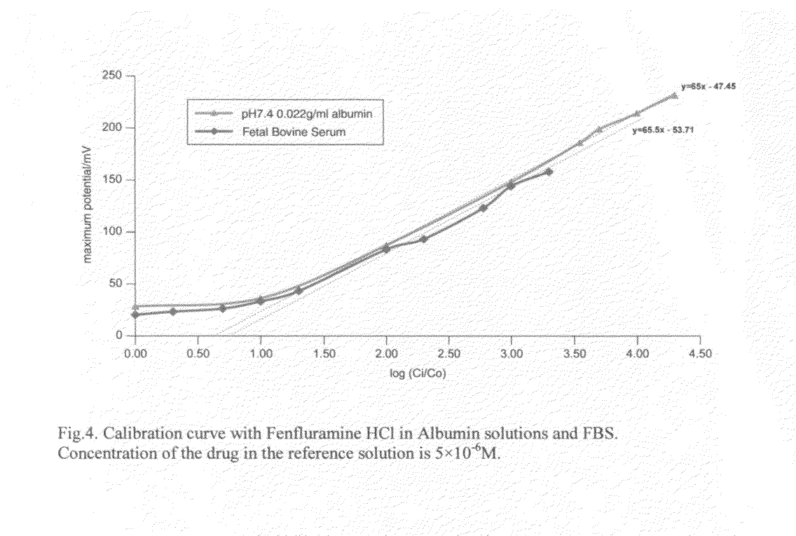

Measurements were conducted at pH 4, 7.4 and 8 of a buffer without and with 1M NaCl (FIG. 3). Separate experiments were conducted with Albumin solution and Fetal Bovine Serum (FIG. 4).

pH 8 yields the highest potentials and the slope equal to 56.4, mV per decade. It is 48.9 and 36.1 mV at pH 7.4 and pH 4, respectively. The time taken to reach the maximum potential was less then a minute at pH 8 and is much higher for pH4 than for pH8. The pH dependence and ionic selectivity organic cation/chloride is determined by impurities of COOH groups present in the nitrocellulose matrix, which are fully dissociated at pH 8, thus resulting in membrane sensitivity to the positively charged molecules of the drug. 1M NaCl decreases the potential. Pretreatment of the porous support with aqueous salt solutions and then impregnation of the dried support additionally decreased the sensitivity and selectivity of the sensors.

### Example 3

### Fenfluramine Hydrochloride in Albumin Solution and FBS

In this case the measuring Ag/AgCl electrode was inserted into the wells with albumin solution with decreasing fenfluramine concentrations, then increasing fenfluramine concentrations, i.e. forward and backward using the same wells. The base solution was buffer. The method allows measurements of fenfluramine from 5×10⁻⁵ to 5×10⁻²M.

### Example 4

### Kinetics of the Potential Formation

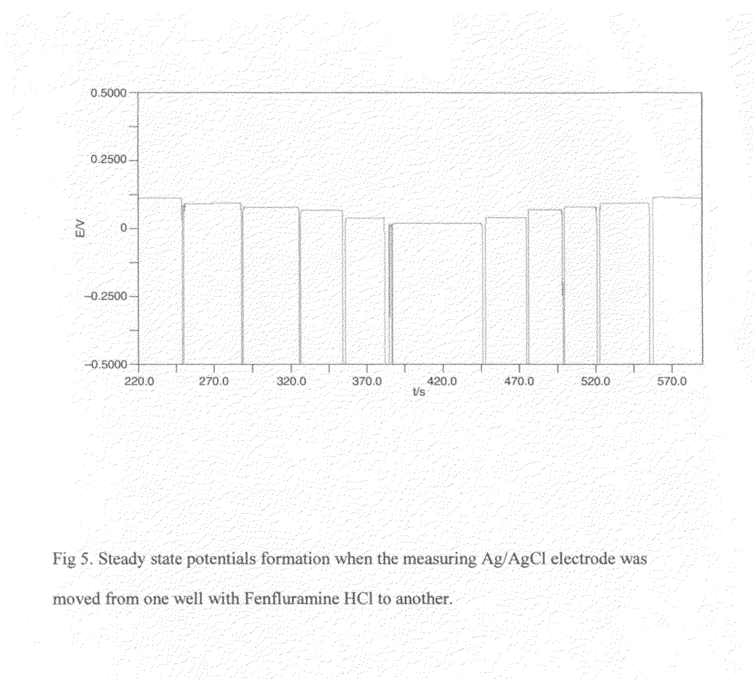

FIG. 5 demonstrates that the response time, necessary for the sensor to give the steady state value is a few seconds when the measuring Ag/AgCl electrode is moved from one well into another with slightly decreasing and then increasing drug concentration.

The steady state potential can decrease in time if one waits at least several minutes due to the slow drug transport through the membrane. After the experiments the membrane could be washed, dried, reimpregnated and after preequilibration used again.

### Example 5

### Kinetics Curves

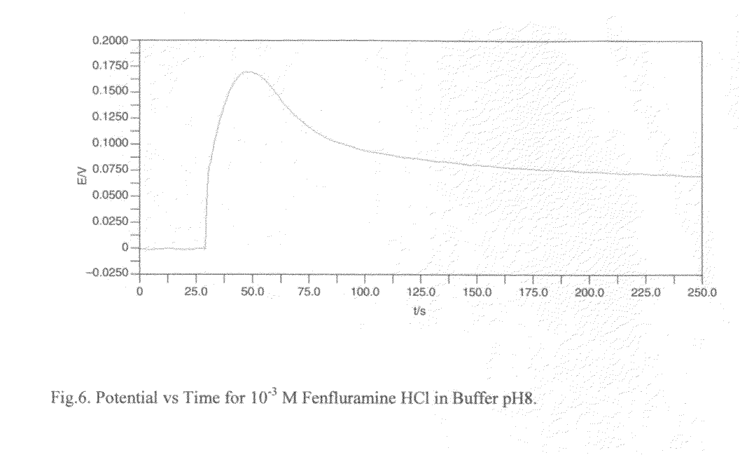

At higher concentrations of the drug after the transmembrane potential reaches its maximum value, it slowly decreases with time due to the transport of the drug (FIG. 6). At pH 8 characteristic time was of the order ˜20 s and increased at more acidic pH to ˜100 s.

### Example 6

### Rimantadine Hydrochloride

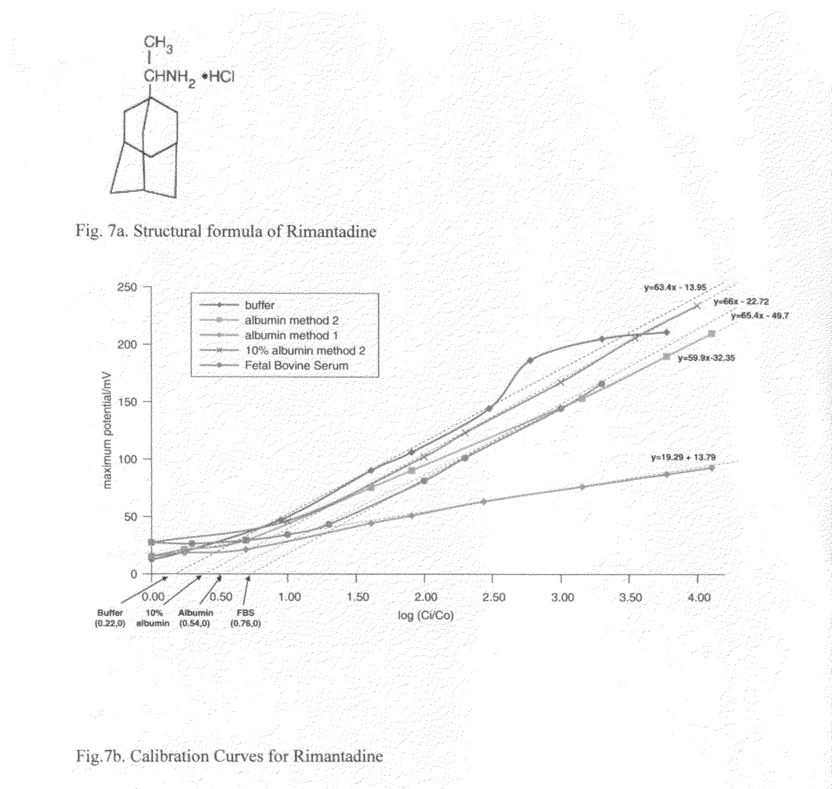

Antiviral and active in Parkinson disease Rimantadine Hydrochloride 1-(1-Adamantyl)ethylamine hydrochloride, C₁₂H₂₁N.HCl (FIG. 7b). Solubility in pH7.4 buffer about 0.05M. Solubility in Fetal Bovine Serum about 0.01 M.

Initial membrane potential had a small positive value probably because of the albumin adsorption in the wells. The base plate had a buffer with the drug as the reference solution.

When the drug was added directly into the albumin solutions in the wells (method 1) it took at least an hr for the potential to reach the steady state and the slope was only 19.3 mV per 10 fold change in Rimantadine concentration because of the drug binding to the protein in the solution (FIG. 7). As expected, a higher protein concentration resulted in the limits of sensitivity shifting to the higher drug concentrations. If different concentrations of rimantadine in albumin solution were preliminary prepared, preequilibrated and then added into the wells (method 2), a gradient was 59.9 mV per 10 fold change in drug concentration, which is similar to that with a buffer solution.

### Example 7

### Chlorpromazine in Buffer and Albumin Solution

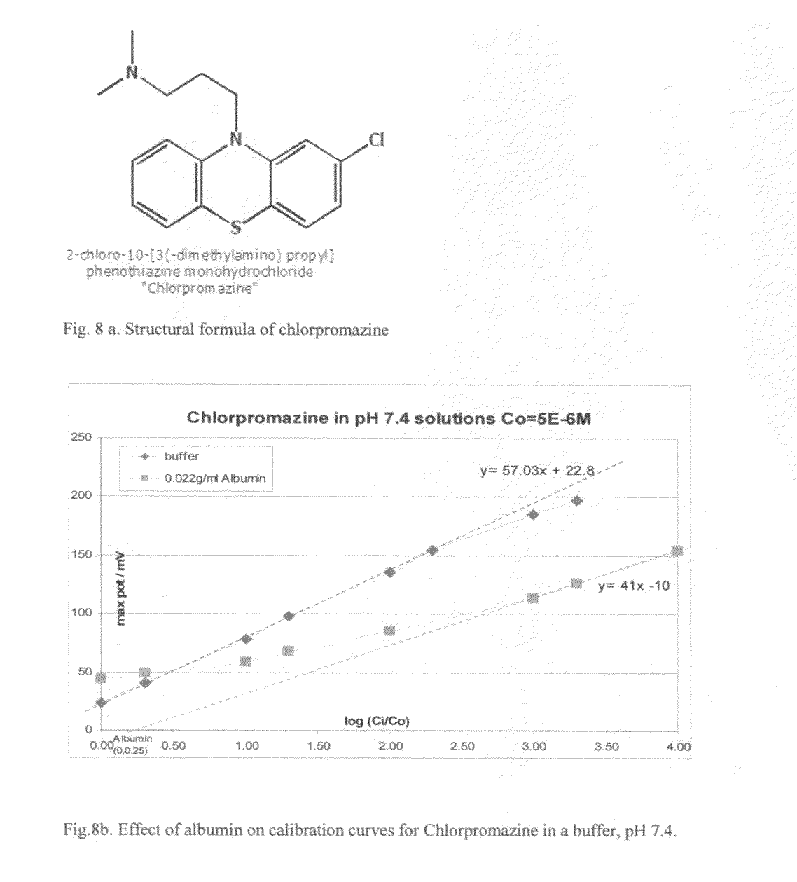

Psychotropic substance Chlorpromazine Hydrochloride 2-chloro-10-[3-dimethylaminopropyl] phenothiazine (FIG. 8a). Critical Micelle Concentration (CMC) is 0.001-0.01M and it decreases as ionic strength increases. The experiments were performed at pH2 to avoid precipitation at neutral pH.

Chlorpromazine test solutions were injected into the wells and the reference solution of 5×10⁻⁶ M Chlorpromazine in the buffer was added into the base. Similar to the results for fenfluramine and rimantadine, the potentials generated for the same concentration are higher with buffer than with albumin solutions and lower limit of sensitivity is increased with albumin addition, also pointing to the drug binding property of albumin (FIG. 8b). At a chlorpromazine concentration near 0.05 M after some time the potential practically disappeared and resistance decreased to only several kilo-ohms. This effect is similar to the lysis of biological membranes and is related to the surface active properties of chlorpromazine. It was observed also with several other psychotropic substances, including several antidepressants. Those of the drugs which induce lysis at elevated concentrations also have nonspecific liver toxicity. The drugs like remantadine do not have this side effect, can be used at high doses in clinics, and they did not result in the membrane lysis in the experiments with biomimetic membrane.

Examples of drugs, which could be measured

| Number | Substance | Activity |
|---|---|---|
| 1 | Rimantadine (Flumadine) | Antiviral |
| 2 | Gramicidine S | Antibiotic |
| 3 | Tetracyclines | Antibiotic |
| 4 | Emoxipine | Antioxidant |
| 5 | Viloxazine | Monocyclic antidepressant |
| 6 | Nomiphenzine | Bicyclic antidepressant |
| 7 | Chlorpromazine, imizine, | Tricyclic antidepressants |
| | amitryptiline, azaphen, azamine | |
| 8 | Ludiomil, incazine | Fourcyclic antidepressants |
| 9 | Pargilin, deprenil | Monoaminooxidase inhibitors |
| 10 | Alkyl ammonium salts | Antiseptics |
| 11 | Glycine esters | Fungicidal |
| 12 | Propranolol | Cardiotropic |
| 13 | Fenfluramine | Antiobesity |

### Example 8

### Calibration

It is easy to calibrate the membrane sensor using slightly modified method of standard additions, thus avoiding possible measurements error determined by membrane variation and aging. It is also possible to detect small deviations from a standard solution, which can be important in mass production and quality control. The standard solution should be used as a reference in the base tray. The text solution (known volume V) of a drug with unknown concentration C₀-Δc can be added in several wells with similar membranes. Then different small volumes Δvᵢ of the solution used for drug preparation should be added into other wells.

Similar to the Nernst equation, equation describing transmembrane potential for nonideal electrode can be simplified for low deviations from standard concentration:

$$Δ E = - \frac{α RT}{F} Lg \frac{{C}_{0} - Δ c}{{C}_{0}} ∼ \frac{α RT}{F} \frac{Δ c}{{C}_{0}} ∼ \frac{α RT}{F} \frac{Δ v}{V}$$

Based on the electrical potential values for several diluted samples it is easy to calculate both α and Δc.

### Example 9

### Nonspecific Liver Toxicity

Some of the drugs have nonspecific liver toxicity because of the interactions with liver cell membranes. At high concentration they are able to destroy membranes and induce liver cirrhosis. After addition of these substances biomimetic membrane looses its barrier properties and ionic selectivity. Electrical resistance decreases by hundred times and transmembrane potential disappears, which is easy to measure and can be used for preliminary screening of potentially liver toxic substances.

Using this sensor it is possible to predict many nonspecific liver toxic effects in a few minutes.

### Example 10

### Sensor with Different Membranes

Another important option is to make a sensor with a system of wells with different membranes, thus making it possible to measure with one sensor several different chemical parameters in different aliquots of the same fluid. For example in addition to the described above biomimetic membranes some membranes could be made with pH-selective glass, some—with PVC and valinomycin to measure K⁺ and some could be with redox active and electroconductive polymers—to measure redox potentials in the solutions.

### Example 11

### Kinetics of the Drug Transport and Metabolism

Sensor can also be used to study kinetics of the drug transport and metabolism by the cells and subcellular structures added as a suspension into the wells and changing the drug concentration as a function of time

I claim:

1. Multiwell membrane-based potentiometric chemical sensor for high throughput tests, said sensor comprising:

1. Multiwell plate with small wells, where the bottoms of the wells have chemically sensitive potentiometric membranes and a reference element—typically Ag/AgCl electrode inserted into the reference aqueous solution located under the bottoms of the wells in contact with the membranes.

2. The sensor of claim 1 where the multiwell plate is made with the electrically nonconductive polymer, so that the electrical signals on different membranes do not influence each other.

3. The sensor of claim 1 where the output of the chemical sensor is a DC transmembrane voltage, measured between additional reference element inserted into the test solution in a well and the first reference element. The potential corresponds to the chemical activity present in different test solutions, which are added into the wells.

4. The sensor of claim 1 where the membrane is a drug sensitive biomimetic membrane. made of porous nitrocellulose polymer support impregnated with lipids or lipid-like substances.

5. The sensor of claim 1 where the membrane is an ion selective glass or polymer membrane,

6. The sensor of claim 1 where the membrane is made with PVC with ionophores.

7. The sensor of claim 1 where the membrane is made of redox active electroconductive polymer including doped polyaniline or polypyrrole membranes to characterize redox processes in the test solutions

8. The sensor of claim 1 wherein said sensor has wells with different selective membranes.
